(19) United States
(12) Patent Application Publication
(10) Pub. No.: US 2013/0041100 A1
(43) Pub. Date: Feb. 14, 2013

(54) PROCESS FOR FORMING A (POLY)URETHANE- AMIDE COMPOUND

(71) Applicants: Steve Diamanti, The Woodlands, TX (US); Nyall A. Tavernier, Houston, TX (US)

(72) Inventors: Steve Diamanti, The Woodlands, TX (US); Nyall A. Tavernier, Houston, TX (US)

(73) Assignee: Huntsman International LLC, The Woodlands, TX (US)

(21) Appl. No.: 13/204,751

(22) Filed: Aug. 8, 2011

(51) Int. Cl. C09D 175/04; C08G 18/00

(52) U.S. Cl. 524/590; 528/44

(57) ABSTRACT

The present invention is directed to a process of forming a (poly) urethane-amide compound comprising reacting an amine compound with a urethane-ester compound under condensation reaction conditions. The urethane-ester compound is formed by reacting an isocyanate containing compound with a hydroxyl-ester compound. The present invention is also directed to a composition comprising the (poly) urethane compound.

### BACKGROUND OF THE INVENTION

1. Field of the Invention

The present invention relates generally to a process for forming a (poly) urethane-amide compound and a composition that comprises such compound.

2. Background Information

It is known in the art that the incorporation of amide moieties into a polyurethane backbone polymer structure can impart certain mechanical and thermal properties to a final end product that comprises the polymer. However, the various processes and methods currently available for incorporating such amide moieties often utilize slow (i.e., total reaction times that are >24 hours) complex chemical reactions that, at times, can require the use of relatively expensive monomers (e.g., cyclic monomers such as caprolactone). All of these factors can contribute to the overall costs associated with the manufacture of amide containing polyurethane polymers and, therefore, there is a need for a process that can address one or more of these shortcomings.

### SUMMARY OF THE INVENTION

The present invention is directed to a process of forming a (poly) urethane-amide compound comprising reacting an amine compound with a urethane-ester compound under condensation reaction conditions and wherein the urethane-ester compound is formed by reacting an isocyanate containing compound with a hydroxyl-ester compound.

The present invention is also directed to a composition comprising a (poly) urethane-amide compound that comprises the reaction product of an amine compound and a urethane-ester compound wherein the reaction is conducted under condensation reaction conditions, and wherein the urethane-ester compound comprises the reaction product of an isocyanate containing compound and a hydroxyl-ester compound.

### DETAILED DESCRIPTION OF THE INVENTION

As used herein, unless otherwise expressly specified, all numbers such as those expressing values, ranges, amounts or percentages may be read as if prefaced by the word “about”, even if the term does not expressly appear. Plural encompasses singular and vice versa. For example, although reference is made herein to “an” amine compound, “a” urethane-ester compound, “an” isocyanate containing compound, “a” hydroxyl-ester compound, a combination (a plurality) of these components can be used in the present invention.

As used herein, “plurality” means two or more.

As used herein, “includes” and like terms means “including without limitation.”

When referring to any numerical range of values, such ranges are understood to include each and every number and/or fraction between the stated range minimum and maximum. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “molecular weight” means weight average molecular weight (M_{w}) as determined by Gel Permeation Chromatography.

### Process

As stated above, the current invention is directed to a process for forming a (poly) urethane-amide compound. The (poly) urethane-amide compound is a polymer, which comprises amide moieties, and which can have a molecular weight of at least 3,000, such as from 3,000 to 200,000 or from 3,000 to 100,000 or from 10,000 to 50,000. The upper limit for the molecular weight of the (poly) urethane-amide compound will be dependent on whether the compound is cross-linked or whether the compound is not cross-linked since a cross-linked polymer can be considered a single polymer chain. Accordingly, a user may tailor the molecular weight of the (poly) urethane-amide compound as desired using techniques that are known in the art. Depending on the various monomers that are used in the reactive ingredients, the (poly) urethane-amide compound that is formed in the process disclosed herein can comprise a variety of reactive functional groups such as hydroxyl, carboxyl, carbamate, epoxy, isocyanate, aceto acetate, amine, mercaptan, or combinations thereof. The reactive functional groups that can be present on the (poly) urethane-amide compound will depend on which reactive ingredient (e.g., (A) urethane-ester compound or (B) amine compound) is in excess in the reactive mixture used to form the (poly) urethane-amide compound.

It has been surprisingly discovered that the process disclosed herein addresses one or more of the shortcoming described above by providing a process for forming a polyurethane polymer that comprises amide moieties which can have a total reaction time that is less than 1 hour, such as less than 30 minutes, while utilizing monomer components that can be less expensive relative to some monomers such as the cyclic monomers described above.

As will be discussed in greater detail below, the (poly) urethane-amide compound of the present invention is the reaction product of (i) a urethane-ester compound and (ii) an amine compound.

The urethane-ester compound is the reaction product of (a) an isocyanate containing compound and (b) a hydroxyl-ester compound. The reactive group ratio between component (a) to component (b) can range from 0.05-20:1, such as from 0.5-2:1 or 0.5-1.1:1. As used in this paragraph, the “reactive group ratio” means the ratio between the number of isocyanate functional groups of component (a) to the number of hydroxyl reactive groups of component (b). In some embodiments, the reaction is continued until either component (a) or component (b), whichever is in excess, is completely consumed. In certain embodiments, the total reaction time for forming the urethane-ester compound is less than four (4) hours in total, such as from 30 minutes to 2 hours, which can aid in reducing the total amount of time needed to form the (poly) urethane-amide compound of the present invention. In certain embodiments, component (a) is present in the reactive mixture at a level ranging from 95 weight % to 20 weight %, such as from 90 weight % to 50 weight %, based on the total weight of components (a) and (b). In some embodiments, component (b) is present in the reactive mixture at a level ranging from 5 weight % to 80 weight %, such as from 10 weight % to 50 weight %, based on the total weight of components (a) and (b).

In certain embodiments, components (a) and (b) are reacted at a temperature ranging from room or ambient temperature (e.g., 25° C.) to 100° C. In some embodiments, the reactive mixture used to form the urethane-ester compound can include an aprotic solvent, which can be polar or non-polar. Whether the aprotic solvent is polar or non-polar will depend on the solubility of components (a) and (b) with the solvent. Suitable aprotic solvents that may be used include, without limitation, toluene, tetrahydrofuran, dimethyl formamide, dimethyl acetamide, or combinations thereof.

It should be understood that the reactive functional groups, molecular weight, and other structural features of the urethane-ester compound can vary depending on the user's desire. For instance, in some embodiments, the urethane-ester adduct has a molecular weight ranging from 150 to 100,000 and an average number of ester moieties ranging from 2 to 20.

In certain embodiments, one or more of the ester moieties will be pendant to the polyurethane polymer backbone of the adduct. It should be appreciated that the formation of this structure will be dependent on the types of monomers used to form the urethane-ester compound. For example, in some embodiments, diethyl tartrate can be reacted with a di-isocyanate compound using reactive conditions known in the art in order to form the pendant ester moieties.

Suitable isocyanate containing compounds that may be used as component (a) include, without limitation, organic polyisocyanates having a number averaged isocyanate (—NCO) functionality of from at least 1.8 to about 4.0 (e.g., 2.0 to 3.0 or 2.0 to 2.7). In certain embodiments, the organic polyisocyanates have a free isocyanate group content (—NCO content) ranging from 5 weight % to 50 weight % (e.g., 7 weight % to 45 weight % or 8 weight % to 40 weight % or 9 weight % to 35 weight % or 10 weight % to 33.6 weight %) based on the total weight of the isocyanate containing compound. As used herein, “organic polyisocyanate” is meant to encompass isocyanate molecular species having a plurality of organically bound free isocyanate (—NCO) groups. This definition includes, without limitation, organic diisocyanates, triisocyanates, higher functionality polyisocyanates, and combinations thereof.

Accordingly, suitable polyisocyanates that may be used in the present invention include, without limitation, any of the aliphatic, cycloaliphatic, arylaliphatic, or aromatic polyisocyanates known in the art such as 1,6-hexamethylenediisocyanate, isophorone diisocyanate, 1,4-cyclohexane diisocyanate, 4,4′-dicyclohexylmethane diisocyanate, 1,4-xylylene diisocyanate, 1,4-phenylene diisocyanate, 2,4-toluene diisocyanate, 2,6-toluene diisocyanate, 4,4′-diphenylmethane diisocyanate (4,4′-MDI), 2,4′-diphenylmethane diisocyanate (2,4′-MDI), polymethylene polyphenylene polyisocyanates (crude, or polymeric, MDI), 1,5-naphthalene diisocyanate, or combinations thereof. Moreover, isocyanate-functional polyisocyanate variants, for example, polyisocyanates that have been modified by the introduction of urethane, allophanate, urea, biuret, carbodiimide, uretonimine, isocyanurate, and/or oxazolidone residues can also be used.

In addition to those isocyanate compounds listed in the preceding paragraphs, it is noted that isocyanate terminated pre-polymers may also be used as component (a). Such prepolymers are generally prepared by reacting a molar excess of polymeric or pure polyisocyanate with one or more polyols using reactive conditions known in the art. The polyols may include aminated polyols, imine or enamine modified polyols, polyether polyols, polyester polyols, polyamines such as alkanol amines, diols and triols having a molecular weight less than 400, or combinations thereof.

Additionally, in certain embodiments, pseudoprepolymers (also known as semiprepolymers or quasiprepolymers) that are mixtures of an isocyanate terminated prepolymer and one or more monomeric polyisocyanates, may also be used as component (a). These polymers can be prepared using techniques that are known in the art.

Suitable hydroxyl-ester compounds that may be used as component (b) include, without limitation, alpha-hydroxy ester compounds (e.g., lactates, glycolates, citrates, tartrates), beta-hydroxy ester compounds, hydroxyl containing esters derived from fatty acids, natural oils containing hydroxyl groups, or combinations thereof.

If desired, a catalyst can be used to promote the formation of the urethane-ester compound described above. Suitable catalysts that may used include, without limitation, tertiary amines, tin-containing compounds, any standard urethane catalyst known in the polyurethane formation art such as triethylene diamine (TEDA), dibutyl tin dilaurate (DBTDL), titanium or zirconium containing compounds (e.g., TYZOR available from DuPont), or combinations thereof. It will be appreciated that the catalyst can be post-added to the reactive mixture after components (a) and (b) have been mixed or it can be added with one or more of components (a) and (b) prior to either of those components being mixed together. While the reactive mixture used to form the urethane-ester compound described above could be catalyst free, in certain embodiments, a catalyst can be used. In these embodiments, the catalyst can be present in an amount ranging from 0.01 weight % to 10 weight %, such as from 0.05 weight % to 1 weight %, based on the total weight of the ingredients used to form the urethane-ester compound minus the weight of any solvents, if any, which are used during the formation of the urethane-ester compound.

It will be appreciated by one skilled in the art that the urethane-ester reaction product may be in the form of a liquid or a solid. The liquid or solid state of the urethane-ester adduct will depend on a variety of factors such as the molecular weight of the reactive ingredients. Accordingly, a user has the flexibility to form a solid or liquid adduct depending on what the user desires.

The urethane-ester compound that is formed in the steps above is then reacted with an amine compound under condensation reaction conditions to form the (poly) urethane-amide compound of the present invention. The reactive group ratio between (A) the urethane-ester compound and (B) the amine compound can range from 0.05-20:1 such as 0.5-2.0:1 such as from 0.9-1.1:1. As used in this paragraph, the “reactive group ratio” means the ratio between the number of ester groups of component (A) to the number of amine groups of component (B). It will be appreciated that, in certain embodiments, the ester moieties of component (A) will react with the amine compound to form the amide moiety found the in the (poly) urethane-amide compound disclosed herein. In certain embodiments, the chemical reaction is conducted at a temperature ranging from −80° C. to 200° C., such as from ambient temperature (e.g., 25° C.) to 100° C., at the aforementioned reactive group ratios. The reaction between components (A) and (B) can range from 1 minute to 8 hours. For example, in some embodiments, the reaction of (A) and (B) can occur at the reactive group ratio and temperatures listed above for a period of time ranging from 15 minutes to 1 hour. In certain embodiments, component (A) is present in the reactive mixture at a level ranging from 5 weight % to 99 weight %, such as from 20 weight % to 90 weight %, based on the total weight of components (A) and (B). In certain embodiments, component (B) is present in the reactive mixture at a level ranging from 95 weight % to 1 weight %, such as from 80 weight % to 10 weight %, based on the total weight of components (A) and (B).

Suitable amine compounds that may be used in the present invention include, without limitation, di-functional amines, polyfunctional amines, or combinations thereof. For example, primary amines, secondary amines, or combinations thereof may be used as the amine compound in the present invention. Examples of such amines include, without limitation, those selected from the group consisting of N,N′-bis(3-aminopropyl)methylamine, N,N′-dimethylethylene diamine, neopentanediamine, 4,4′-diaminodiphenyl methane and 2-methylpentamethylenediamine (such as DYTEK A available from Invista, Wilmington, Del., U.S.A.). Additionally, polyetheramines (such as JEFFAMINE polyetheramines available from the Huntsman Corporation, The Woodlands, Tex., U.S.A.), may be used in the invention including JEFFAMINE D series having the structure

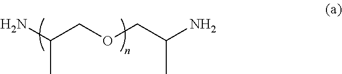

wherein n is 2.5 to 68, JEFFAMINE EDR series having the structure;

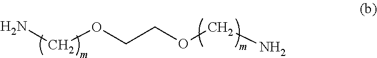

where m is 2 to 3, and JEFFAMINE T series having the structure; or

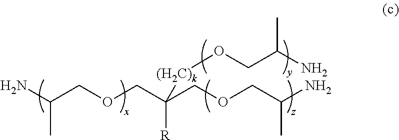

where R is H or C₂H₅, k is 0 or 1, and the total of x, y, and z is 5 to 85. In certain embodiments, a combination of (a), (b), and (c) may be used. In addition to the preceding amine compounds, JEFFAMINE D400 and D2000, hexane diamine, butane diamine, ELASTAMINE HT1700, or combinations thereof can also be used as component (B).

If desired, a catalyst can be used to promote the formation of the (poly) urethane-amide compound of the present invention. Suitable catalyst that may used include, without limitation, Lewis acids and bases, Bronstead acids and bases, or combinations thereof. Accordingly, suitable catalysts that may be used include, without limitation, tin octoate, acetic acid, potassium tert-butoxide, or combinations thereof. It will be appreciated that the catalyst can be post-added to the reactive mixture after components (A) and (B) have been mixed or it can be added with one or more of components (A) and (B) prior to either of those components being mixed together. While the reactive mixture used to form the (poly) urethane-amide compound described above could be catalyst free, in certain embodiments, a catalyst can be used. In these embodiments, the catalyst can be present in an amount ranging from 0.01 weight % to 10 weight %, such as 0.05 weight % to 1.5 weight %, based on the total weight of the ingredients used to form the urethane-ester compound minus the weight of any solvents, if any, which are used during the formation of the urethane-ester compound.

While in some embodiments that reactive mixture that is used to form the (poly) urethane-amide compound is solvent free, in certain embodiments, a small amount of a polar aprotic solvent (e.g., dimethylformamide or dimethyl sulfoxide) can be used to reduce the viscosity of the reactive mixture. In these embodiments, the solvent may be used in an amount that does not exceed the total amount of the (B) amine compound present in the reactive mixture. For example, in certain embodiments, the solvent is used in an amount ranging from 5 weight % to 95 weight % based on the total weight of the components used to form the (poly) urethane-amide compound.

In some embodiments, the reactive mixture that is used to form the (poly) urethane-amide compound is free of an isocyanate compound. That is, there are no compounds in the reactive mixture comprising components (A) and (B) that comprises an isocyanate functional group.

In certain embodiments, there is no deliberate intermediate chemical reaction between the formation of the urethane-ester compound and the reaction between the urethane-ester compound and the amine compound. That is, the urethane-ester reaction product that is formed is not intentionally subjected to any other type of chemical reaction prior to being reacted with the amine compound described above.

### Composition

The (poly) urethane-amide compound made by the process described above can be incorporated into a variety of compositions that can be used to make various end products.

In certain embodiments, the (poly) urethane-amide compound of the present invention can be incorporated as a component of a coating composition. For example, coating compositions, such as paint, often utilize urethane polymers as a component of the coating. The (poly) urethane-amide compound that is formed through the present invention could be incorporated into such a coating composition to impart certain physical and thermal properties to the coating that is formed from the composition. One potential advantage of using the (poly) urethane-amide compound in a coating composition is that the possibility of air bubble formation during coating formation might be reduced due to the fact that there are no isocyanate groups or compounds to react with atmospheric water.

Additionally, the (poly) urethane-amide compound can be used in the formation of polyurethane based polymers and elastomers. For example, depending di-functional isocyanate compounds and/or amine compounds can be used as reactive ingredients in the formation of the (poly) urethane-amide compound. By using these di-functional monomers, an thermoplastic polyurethane material comprising the (poly) urethane-amide compound can be formed. Alternatively, if polyfunctional isocyanate and/or amine monomers having more than two functional groups are used in lieu of the di-functional monomers described above, then an elastomer comprising the (poly) urethane-amide compound can be formed. One potential advantage of using the (poly) urethane amide-compound of the present application in an elastomer is the possibility of reducing air bubble formation (i.e., foaming) during the formation of the elastomer. Accordingly, a full density elastomeric product could potentially be made which would exhibit improved mechanical properties (e.g, tensile strength) when compared to an elastomer that does not utilize the urethane-amide compound of the present invention.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof. Therefore, any of the features and/or elements which are listed above may be combined with one another in any combination and still be within the breadth of this disclosure.

### EXAMPLE

### Synthesis of a Urethane-Ester Compound

300 g of xylenes were added to a 500 mL three-neck, round bottom flask. This flask was dropped into a 75° C. oil bath and an overhead stirring apparatus was attached. 150 mg (0.1 wt %) of DABCO catalyst and 75 g ethyl lactate were then added to this solution. Finally, 75 g of RUBINATE 44, from a ‘melted out’ stock supply in an 80° C. oven, was poured into an addition funnel connected to one of the flask's necks. A heat gun was used to prevent RUBINATE 44 recrystallization. The addition funnel's contents were then added drop wise over a 15 minute period. Attenuated Total Reflectance Fourier Transform Infrared Spectroscopy (from Thermo Fisher Scientific) was used to track the intensity reduction of the isocyanate peak, seen at approximately 2250 cm⁻¹. Significant reduction was seen after 2.25 hours. At that point, the flask was removed from the oil bath and allowed to cool to room temperature. During this cooling, precipitation occurred resulting in the formation of a white solid. This could be promoted by placing the flask in an ice bath to further decrease the product's solubility in xylenes. The product was isolated by vacuum filtration over a three day period.

### Synthesis of a (Poly) Urethane-Amide Compound:

13.8 g of JEFFAMINE D2000 and 11.1 g of JEFFAMINE D400 (from Huntsman) were poured into an 8 oz. jar making a 2:8 blend. The jar was then placed in a 100° C. oil bath and an overhead mixing apparatus was established. Afterwards, 0.41 mL tin octoate catalyst (a 1.25 wt % loading) was added to the blend. Finally, 16 g of the urethane-ester compound synthesized above (Rubinate 44/Ethyl Lactate adduct) was added. The (poly) urethane-amide compound was formed by stirring and heating the reactive mixture for a period of five hours.

What is claimed is:

1. A process of forming a (poly) urethane-amide compound comprising reacting an amine compound with a urethane-ester compound under condensation reaction conditions and wherein the urethane-ester compound is formed by reacting an isocyanate containing compound with a hydroxyl-ester compound.

2. The process according to claim 1, wherein the hydroxyl-ester compound comprises an alpha-hydroxy ester compound.

3. The process according to claim 1, wherein the reactive ingredients used to form the urethane-amide compound comprises a catalyst.

4. The process according to claim 3, wherein the catalyst comprises a Lewis acid or base, a Bronstead acid or base, or combinations thereof.

5. The process according to claim 1, wherein the reactive group ratio of (a) the isocyanate containing compound to (b) the hydroxyl-ester compound ranges from 0.05-20:1; wherein the reaction is continued until either the isocyanate containing compound or the hydroxyl-ester compound is consumed; and wherein the reactive group ratio means the ratio between the number of isocyanate functional groups of component (a) to the number of hydroxyl groups of component (b).

6. The process according to claim 5, wherein the reactive mixture to form the urethane-ester compound comprises a urethane catalyst.

7. The process according to claim 6, wherein the catalyst tertiary amines, tin-containing compounds, titanium containing compounds, zirconium containing compounds, or combinations thereof.

8. The process according to claim 1, wherein the step of reacting the amine compound with the urethane-ester compound is conducted at a temperature ranging from −80° C. to 200° C. and wherein the reactive group ratio of (A) the urethane-ester compound to (B) the amine compound ranges from 0.05 to 20:1, wherein the reactive group ratio means the ratio between the number of ester groups of component (A) to the number of amine groups of component (B).

9. The process according to claim 1, wherein reaction to form the (poly) urethane-amide compound occurs in less than 8 hours.

10. The process according to claim 1, wherein there is no intermediate chemical reaction process step between the formation of the urethane-ester compound and the reaction between the urethane-ester compound and the amine compound.

11. The process according to claim 1, wherein the reactive mixture used to form the (poly) urethane-amide compound is solvent free.

12. The process according to claim 1, wherein the reactive mixture used to form the (poly) urethane-amide compound comprises a polar aprotic solvent.

13. The process according to claim 1, wherein the step of making the (poly) urethane-amide compound is free of isocyanate compounds.

14. A composition comprising a (poly) urethane-amide compound that comprises the reaction product of an amine compound and a urethane-ester compound wherein the reaction is conducted under condensation reaction conditions, and wherein the urethane-ester compound comprises the reaction product of an isocyanate containing compound and a hydroxyl-ester compound.

15. The composition according to claim 14, wherein the composition is a polyurethane composition.

16. The composition according to claim 14, wherein the hydroxyl-ester compound comprises an alpha-hydroxy ester compound.

17. The composition according to claim 14, wherein the reactive ingredients used to form the urethane-amide compound comprises a catalyst.

18. The composition according to claim 17, wherein the catalyst comprises a Lewis acid, a Bronstead acid, or combinations thereof.

19. The composition according to claim 14, wherein the composition comprises a coating composition, an elastomeric composition, or a thermoplastic polyurethane composition.
